(19) United States
(12) Patent Application Publication
(10) Pub. No.: US 2025/0076226 A1
(43) Pub. Date: Mar. 6, 2025

(54) METAL OXIDATION DETERMINING APPARATUS

(71) Applicant: Adaptix Ltd, Begbroke (GB)

(72) Inventor: Robert Cernik, Begbroke (GB)

(21) Appl. No.: 18/951,965

(22) Filed: Nov. 19, 2024

Related U.S. Application Data
(63) Continuation of application No. PCT/GB2023/051255, filed on May 12, 2023.

(30) Foreign Application Priority Data
May 19, 2022 (GB) 2207362.1

(51) Int. Cl. G01N 23/20008; G01N 23/2055

(52) U.S. Cl. CPC G01N 23/20008; G01N 23/2055; G01N 2223/628

(57) ABSTRACT

It is desirable to be able to determine the presence of metal oxidation on a pipe (10), wherein the pipe includes insulation (20) around its outer surface (15), without removing the insulation. An apparatus is provided comprising an x-ray emitter (30), and an x-ray detector (40), the apparatus arranged to identify the presence of metal oxidation by virtue of the diffraction characteristics of the detected x-rays.

### RELATED APPLICATIONS

This application claims the benefit under 35 U.S.C. § 120, and is a continuation, of co-pending International Application PCT/GB2023/051255, filed May 12, 2023 and designating the US, which claims priority to GB Application 2207362.1, filed May 19, 2022, such GB Applications also being claimed priority to under 35 U.S.C. § 119. These GB and International applications are incorporated by reference herein in their entireties.

### FIELD

The present invention relates generally to a metal oxidation determining apparatus and a method of determining the presence of metal oxidation on a pipe, and finds particular, although not exclusive, utility in monitoring the condition of metal pipes which are covered in insulation.

### BACKGROUND

Metallic pipes, made of iron or steel for instance, often corrode due to the presence of moisture in the air around them. This occurs even when the pipes are surrounded in insulation. Such corrosion leads to failure of the pipes and therefore it is important to check the condition of the pipes and take steps to avoid such failure.

It is known to cut holes in the insulation and visually check the pipes. However, this method cannot be used to check all of the surface of the pipe as otherwise all of the insulation would have to be removed and replaced.

Another known method is the use of real-time-radiography which provides a 2D x-ray profile of the pipe's outer diameter. This profile can be viewed in real time on a display screen. A profile change is indicative of corrosion but cannot positively detect, nor measure, the corrosion on a pipe and is also prone to generate false indications.

Ultrasonic testing can be used to measure wall thickness of the pipe based on the ultrasound waves' ‘time-of-flight’. Again, this provides only an indication of change of pipe-wall thickness. This inspection capability cannot positively confirm the presence of corrosion. For this method to work, inspection plugs are required to be cut into the insulation which needs repairing afterwards, increasing inspection cost.

Pulsed Eddy Current is another known system, however, again, it only determines the thickness of the pipe wall.

Therefore, all of these later methods measure pipe-wall thickness but cannot discern between an increase of oxide material (rust) versus a loss of wall thickness (from the action of corrosion), which could lead to the appearance of a uniform pipe (no material change in thickness).

### SUMMARY

It is desirable to determine, with more assurance, the presence of corrosion (oxidation) on insulated pipes without having to remove any of the insulation.

In a first aspect, the present invention provides metal oxidation determining apparatus for determining the presence of metal oxidation on a pipe, wherein the pipe includes insulation around its outer surface, the apparatus comprising an x-ray emitter, and an x-ray detector, the apparatus arranged to identify the presence of metal oxidation by virtue of the diffraction characteristics of the detected x-rays.

The x-rays may be emitted at 160 keV, although other levels are contemplated, such as in the range 60 to 90 keV.

The x-ray emitter may be a flat panel array of emitters, or a single source may be used. The detector may be a flat panel detector.

The metal oxidation determining apparatus may comprise attachments means for attaching the apparatus to the outside of the insulation surrounding the pipe. For instance, clamps.

The metal oxidation determining apparatus may comprise x-ray emitter adjustment means for positioning the emitter such that the x-rays emitted at a tangent to the surface of the pipe underneath the insulation. In this regard, the x-ray emitter may be adjusted such that the x-rays travel through the outside edge of the pipe to a maximum depth of 1 mm, although other depths are contemplated.

The metal oxidation determining apparatus may comprise x-ray detector adjustment means for positioning the detector to receive the x-rays emitted after they have travelled at a tangent to the surface of the pipe underneath the insulation.

The adjustment means for the emitter and/or detector may comprise a rack and pinion system.

The metal oxidation determining apparatus may comprise movement means for moving the apparatus along the linear axis of the pipe. For instance, motorised tracks and/or wheels may be provided.

The metal oxidation determining apparatus may comprise a means of determining its position relative to the pipe. For instance, a GPS may be provided. Alternatively, or additionally, a means for reading a fiducial marker located on the pipe may be provided. The fiducial marker may be a tape arranged on the pipe or in or on the insulation. The tape may include elements which are visible to the apparatus such as by analysis of the x-ray images. Alternatively, or additionally, a movement recording means may be provided. For instance, a tachometer may be provided.

The metal oxidation determining apparatus may comprise movement means for moving the apparatus around the circumference of the pipe. This may include a rack and pinion system, or driven wheels.

In a second aspect, the invention provides a method of determining the presence of metal oxidation on a pipe, wherein the pipe includes insulation around its outer surface, comprising the steps of providing a metal oxidation determining apparatus according to the first aspect, placing said apparatus on said pipe, and operating said apparatus.

### BRIEF DESCRIPTION OF THE DRAWINGS

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 is a cross-sectional view of an insulated pipe and an apparatus for determining the presence of metal oxidation on a pipe.

### DETAILED DESCRIPTION

The present invention will be described with respect to certain drawings but the invention is not limited thereto but only by the claims. The drawings described are only schematic and are non-limiting. Each drawing may not include all of the features of the invention and therefore should not necessarily be considered to be an embodiment of the invention. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that operation is capable in other sequences than described or illustrated herein. Likewise, method steps described or claimed in a particular sequence may be understood to operate in a different sequence.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term “connected”, used in the description, should not be interpreted as being restricted to direct connections only. Thus, the scope of the expression “a device A connected to a device B” should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other. For instance, wireless connectivity is contemplated.

Reference throughout this specification to “an embodiment” or “an aspect” means that a particular feature, structure or characteristic described in connection with the embodiment or aspect is included in at least one embodiment or aspect of the present invention. Thus, appearances of the phrases “in one embodiment”, “in an embodiment”, or “in an aspect” in various places throughout this specification are not necessarily all referring to the same embodiment or aspect, but may refer to different embodiments or aspects. Furthermore, the particular features, structures or characteristics of any one embodiment or aspect of the invention may be combined in any suitable manner with any other particular feature, structure or characteristic of another embodiment or aspect of the invention, as would be apparent to one of ordinary skill in the art from this disclosure, in one or more embodiments or aspects.

Similarly, it should be appreciated that in the description various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Moreover, the description of any individual drawing or aspect should not necessarily be considered to be an embodiment of the invention. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may mean only one in certain circumstances. The use of the term “any” may mean “all” and/or “each” in certain circumstances.

The principles of the invention will now be described by a detailed description of at least one drawing relating to exemplary features. It is clear that other arrangements can be configured according to the knowledge of persons skilled in the art without departing from the underlying concept or technical teaching, the invention being limited only by the terms of the appended claims.

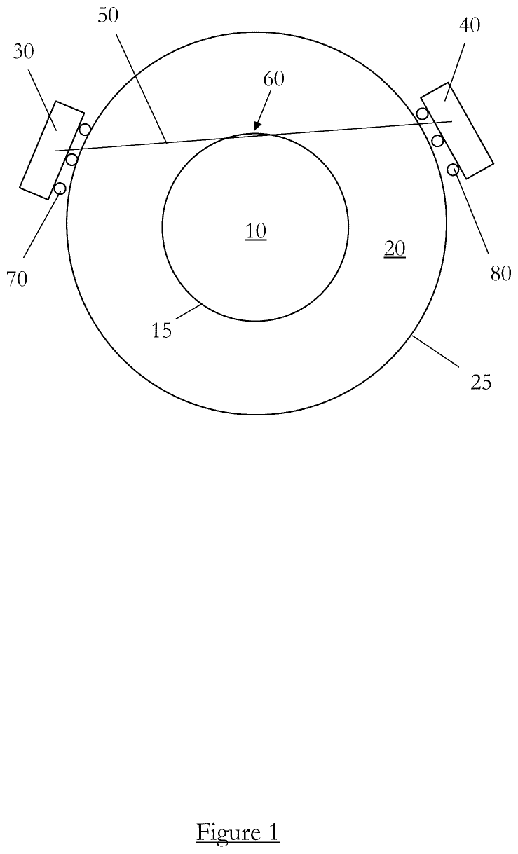

FIG. 1 shows the cross section through a pipe 10 having an outer wall 15. The pipe is surrounded by insulation 20 having an outer surface 25. The insulation may comprise mineral wool.

The apparatus may comprise an x-ray emitter section 30 and an x-ray detector section 40. Each section may be arranged on opposite sides of the pipe such that the x-rays 50 cross through the upper surface of the pipe wall 15, as indicated by reference “60”.

Each section may include means 70, 80 for moving along the longitudinal length and/or around the circumference of the outer surface 25 of the pipe insulation 20.

The x-rays may be diffracted by their passage through the upper surface 15 of the pipe 10. The detector 40 is arranged to receive the x-rays. A processor may be provided (not shown) which analyses the diffraction patterns in the received x-rays to determine the presence of metal oxides. In this regard, the processor may be able to identify the material through which the x-rays have passed so as to determine if it is solid metal and/or metal oxides. The presence of metal oxides may indicate the presence of corrosion of the pipe.

It has been found that the insulation does not interfere with the diffraction patterns created by the pipe and/or may be filtered out by the processor.

1. Metal oxidation determining apparatus for determining the presence of metal oxidation on a pipe, wherein the pipe includes insulation around its outer surface, the apparatus comprising an x-ray emitter, and an x-ray detector, the apparatus arranged to identify the presence of metal oxidation by virtue of the diffraction characteristics of the detected x-rays.

2. The metal oxidation determining apparatus of claim 1, comprising attachment means for attaching the apparatus to the outside of the insulation surrounding the pipe.

3. The metal oxidation determining apparatus of claim 1, comprising x-ray emitter adjustment means for positioning the emitter such that the x-rays are emitted at a tangent to the surface of the pipe underneath the insulation.

4. The metal oxidation determining apparatus of claim 1, comprising x-ray detector adjustment means for positioning the detector to receive the x-rays emitted after they have travelled at a tangent to the surface of the pipe underneath the insulation.

5. The metal oxidation determining apparatus of claim 1, comprising movement means for moving the apparatus along the linear axis of the pipe.

6. The metal oxidation determining apparatus of claim 1, comprising a means of determining its position relative to the pipe.

7. The metal oxidation determining apparatus of claim 6, wherein the means of determining its position include any one or more of a GPS, means for reading a fiducial marker located on the pipe, and movement recording means.

8. The metal oxidation determining apparatus of claim 1, comprising movement means for moving the apparatus around the circumference of the pipe.

9. A method of determining the presence of metal oxidation on a pipe, wherein the pipe includes insulation around its outer surface, including the steps of providing a metal oxidation determining apparatus, the metal oxidation determining apparatus comprising an x-ray emitter, and an x-ray detector, the metal oxidation determining apparatus arranged to identify the presence of metal oxidation by virtue of the diffraction characteristics of the detected x-rays; the method further including the step of placing the apparatus on the pipe, and operating the apparatus.

10. The method of claim 9, the apparatus further comprising attachment means for attaching the apparatus to the outside of the insulation surrounding the pipe; and x-ray emitter adjustment means for positioning the emitter relative to the pipe; the method including the steps of attaching the apparatus to the outside of the insulation surrounding the pipe; and positioning the emitter relative to the pipe such that the x-rays are emitted at a tangent to the surface of the pipe underneath the insulation.

11. The method of claim 10, the apparatus further comprising x-ray detector adjustment means for positioning the detector relative to the pipe; the method including the step of positioning the detector so as to receive the x-rays emitted after they have travelled at a tangent to the surface of the pipe underneath the insulation.

12. The method of claim 9, the apparatus further comprising movement means for moving the apparatus along the linear axis of the pipe; the method including the step of moving the apparatus along the axis of the pipe; and determining the presence of metal oxidation.
